(19) United States
(12) Patent Application Publication
(10) Pub. No.: US 2013/0298013 A1
(43) Pub. Date: Nov. 7, 2013

(54) System and Method for Generation of a Layout of Document Elements

(71) Applicant: Andrew Hunter, Bristol (GB)

(72) Inventor: Andrew Hunter, Bristol (GB)

(21) Appl. No.: 13/880,774

(22) PCT Filed: Jan. 25, 2011
(86) PCT No.: PCT/US11/22406

§ 371 Date: Apr. 22, 2013

(51) Int. Cl. G06F 17/21

(52) U.S. Cl. CPC G06F 17/212
USPC 715/243

(57) ABSTRACT

A system (10, 200) to arrange content in a layout can include memory (206) to store computer executable instructions and a processor (204) to access the memory and execute the computer executable instructions. The computer executable instructions can include a layout generator (14, 208) to determine element variations for each of a plurality of document elements (16, 212) of a layout of hierarchically structured content (16, 228) and to arrange each of the element variations in the layout to determine plural different permutations for the layout based on layout rules at each level of hierarchy of the layout.

### BACKGROUND

Tools exist for building and editing documents. However, many existing tools for retrieving and manipulating content from other sources can be difficult for many users to implement. For instance, some tools employ complex interfaces may require detailed knowledge of the tool to build documents. Additionally, many systems are too constrained for producing document types with rich layouts to produce magazine-like pages and spreads.

### BRIEF DESCRIPTION OF THE DRAWINGS

FIG. 1 depicts an example of a system for generation of a layout for a complex document.

FIG. 2 depicts an example of a complex document.

FIG. 3 depicts an example of a data structure representation of a complex document.

FIG. 4 depicts an example of another system for generating a layout for a complex document.

FIG. 5 is a flow diagram depicting an example of a method for a permutation engine.

FIG. 6 is a flow diagram depicting an example of a method for generating a layout for a complex document,

### DETAILED DESCRIPTION

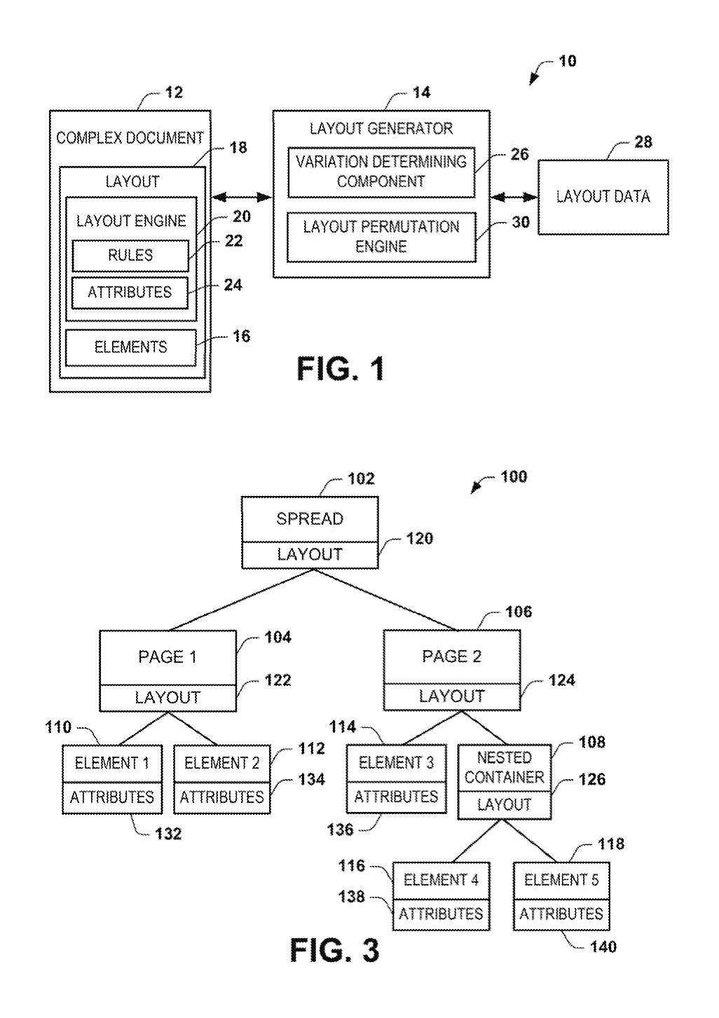

FIG. 1 depicts an example of a system 10 that can be utilized to generate a layout for a complex document 12. The system 10 includes a layout generator 14 that can be activated to generate the layout by arranging content elements 16 according to a layout 18. For instance, the layout generator 14 can be implemented as an automated process that is invoked in response to a user input, such as adding new content to the complex document or otherwise activating the layout generator (e.g., by selecting a graphical user interface element or button or pressing a predefined button or key). The layout generator 14 can also be called by another application to compute a corresponding layout. In one implementation, the layout generator 14 generates the layout from a hierarchical structure of both content elements (e.g., text blocks and graphical objects) and structuring containers and layouts. The layout generator 14 thus can employ and preserve the hierarchical structure to determine a set of valid layout permutations according to layout rules and element attributes. A user can select one or more layouts from the set of valid layouts. Each of the valid permutations can preserve and visually express the original hierarchical structure of the complex document. in this way, less sophisticated users can produce rich pleasing magazine-like layouts, which can adapt to changes in content without the user having to be skilled in the aesthetics of magazine design and design interfaces.

As used herein, the term “includes means includes but not limited to, the term including” means including but not limited to. The term “based on” means based at least in part on.

As used herein, a complex document refers to a document that contains a group of content elements selected from the group comprising text elements, graphical elements, multimedia (e.g., audio, video, or audio-video) elements and image elements residing in containers with associated layout formats. An image element is a pixel array, such as, for example, a photo. A graphical element can be a pixel array but may often have a vector representation (including scalable vector graphics (SVG)) associated with the graphical. The vector representations are readily scaleable without the loss of quality. Graphical elements can be used for borders and decoration, color gradients, logos, diagrams and the like. A text element can be a block of text, page number, a figure index or a header. Text of a header can include an emphasis, such as large text. bolding, underling, etc. and a tag (e.g., specified by a designer a priori) to identify that it is to be put at a top of a layout or arranged first in a layout. The layout of these elements can be fully two dimensional, such that it is not restricted to folding a one dimensional thread of characters and images into a fixed column or page of the complex document.

A columnar layout refers to a complex document or a portion thereof that has a defined column structure that is defined by a columnar layout engine. The column structure is imposed on a valid arrangement of elements located in the column structure. A columnar layout can also comprise another layout (e.g., another multi-columnar layout, a Blocked Recursive Image Composition (BRIC) layout or other type of layout), which is referred to as a nested layout. The layout generator 14 can employ and preserve the layout defined by containers that are arranged in other containers.

In the example layout 18 of FIG. 1, a layout engine 20 can employ rules 22 and layout attributes 24 to constrain a valid arrangement of content elements 16 within the layout 18 within a given region (e.g., a container) as determined by each layout engine and associated rules. In one example, the layout 18 can be implemented as a columnar layout and layout attributes 24 can be utilized to constrain the columnar arrangement of elements, such as to have a width to fit within a single column or a width of more than one contiguous column and any inter-column gap.

The complex document 12 can further be represented for computation by a hierarchical structure of containers and content elements. As used herein, a container refers to a structure having a layout format that can hold a group of one or more of the elements 16. Each container can further include a container-specific layout engine and layout parameters (e.g., layout rules) to be used to arrange elements therein. The container-specific layout engine arranges and modifies the elements in its container to fill the shape and size of the available surface (e.g., page) by applying rules to elements and their properties The layout engine can also work in conjunction other layout engines for containers further up or down the hierarchy. For example, a columnar layout engine for a page can constrain the Block Recursive Image Composition (BM) layout for a nested container such that the layout of images fit within one or more contiguous columns.

Containers can include one or more other containers nested therein to support complex documents which define nested layouts. Examples of containers include pages, spreads including two facing pages, a group of images, a group of images with titles and others. As mentioned above, additional layouts can also be nested within the layout structure. It will be understood, however, that that the columns of a columnar layout act as constraints on the sizes and positions of the elements but the columns are not separate containers.

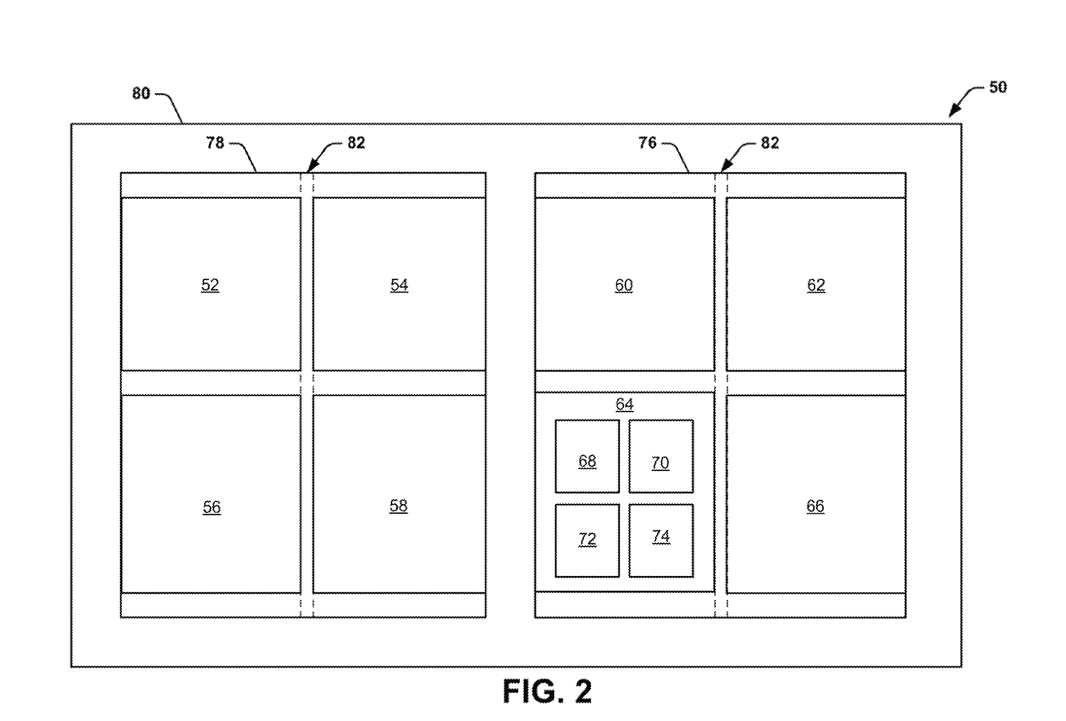

By way of example, FIG. 2 illustrates an example block diagram of a complex document 50, such as can be generated by the layout generator 14 of FIG. 1. The complex document 50 includes an arrangement of elements 52, 54, 56, 58, 60, 62, 64, 66, 68, 70, 72 and 74, such as can include image elements, text elements and layout elements. The elements 68, 70, 72 and 74 reside within a nested layout 64, such as can be a columnar layout or another type of layout element (e.g., a BRIC layout). The nested layout element 64 and content element 60 are constrained to lie in a common column of a page layout 76. The elements 62 and 66 are constrained to lie in another column of the page layout container 76. The elements 52 and 56 are constrained to lie in common column of another page layout container 78, while 54 and 58 are constrained to lie in yet another column of the same page layout. An inter-column gap 82, which is demonstrated as dashed lines, can be a user defined attribute of the columnar layout for the document 50. The complex document 50 also includes page layout containers 76 and 78 that reside in a spread layout 80 containing the two respective pages.

Examples of a complex document that may include columnar layouts can be a magazine, a book, a newspaper, a periodical or other publishable type of document having a columnar layout. The content elements 52, 54, 56, 58, 60, 62, 64, 66, 68, 70, 72 and 74 can be manipulated and edited within the target complex document 50, including automated generation of a columnar layout for elements in the entire complex document or a selected portion thereof. While the example complex document 50 of FIG. 2 illustrates elements having single column widths, it will be understood that a given element can have a width of any number of one or more columns, which can be calculated by the columnar layout engine (e.g., the layout engine 20 of FIG. 1) based on column layout attributes and attributes of the given element. While the example complex document 50 of FIG. 2 is demonstrated as having a columnar layout, it will be understood that other types of layouts and nested layouts can also be generated.

Referring back to FIG, 1, the layout generator 14 is programmed to generate a layout for the complex document 12. The layout generator 14 includes a variation determining component 26 to determine a set of element variations for each element of a set of document elements 16 in the layout 18. The element variations can include size and shape of each respective element. The variation determining component 26 can determine variations of the shape of the content elements. The variation determining component 26 can also determine variations of the shape of any contained logical containers, which may themselves be columnar layouts or may be some other types of layouts.

As mentioned above, the document elements 16 correspond to hierarchically structured content. The variation determining component 26 can determine the element variations recursively, such as progressing upwardly from lower levels of hierarchy in the structured content of the complex document 12. The variation determining component 26 can determine element variation data for each of the elements 16 in a first phase or for selected elements intermittently during the layout process.

Attributes of the elements (e.g., for both container elements and graphical elements) can be utilized to limit the number of variations determined for a given element. The variation determining component can evaluate the element variation relative to its attributes and if the element variation violates a constraint defined by its attribute, such violating variation of the element can be eliminated (e.g., discarded). For instance, an element may have an attribute that specifies a minimum or maximum width. Thus, by the variation determining component using the attributes to eliminate certain size and shape variations, the resulting number of layout permutations (described herein below) can be significantly reduced. The set of valid variations of elements (e.g., different shape and size) can be stored as element variation data in layout data 28.

For the example of a columnar layout, the size and shape variations for the elements can further be constrained according to columnar layout attributes, such as can specify the number of columns that fit within the available layout space provided by the complex document 12. As a further example, the layout attributes 24 for a columnar layout can include a column width attribute and an inter-column gap attribute. The columnar layout engine 20 can thus calculate the number of columns that can be fitted onto the layout space of the complex document 12 based on such column attributes. The size and shape variations for the elements can also be limited by the attributes of the respective elements, which can constrain the size and/or position of a particular element. For example. if a columnar layout has three columns, and a particular one of the elements has an attribute requiring a minimum width of two columns, then that element may be limited to a width of two columns plus one inter-column gap, or three columns plus two inter-column gaps.

The layout generator 14 can also include a layout permutation engine 30 to arrange the document elements in the layout 18 and determine plural different permutations according to the variations determined by the variation determining component 26. Each layout permutation may include only one variation of each of the elements of the layout based on layout rules 22 associated with the layout 18. The layout permutation engine 30 can be programmed to determine a set of all possible valid layout permutations for the determined variations of the elements 16. Alternatively, the layout permutation engine 30 can run until a predetermined sufficient number of permutations have been found or until a certain period of computation has elapsed. There may be hundreds, thousands or even millions of valid layout permutations. The layout generator 14 thus can provide a subset of corresponding valid layout permutations from the set of all possible layout permutations determined by the permutation engine 30 and this subset of permutations can be stored in the layout data.

In one example, each valid layout permutations can be encoded as an ordered sequence of variations for each contained element in a respective permutation. That is, each sequence of variations is sufficient to uniquely record a valid layout without having to explicitly record the positions, widths and heights of all the elements. The layout rules of each layout engine in the hierarchically structured complex document 12 can determine the mapping from the sequence to the valid layout according to the particular visual style of the respective layout engine. Accordingly, each valid layout permutation can be easily reconstructed from the ordered sequence of element variations without having to store details of how each particular element is arranged in each and every permutation.

As an example, the permutation engine 30 can determine the set of valid layout permutations by recursively progressing through the set of element variations (e.g., size and shape) until all valid layout permutations from an original set of layout permutations have been found. For instance, the permutation engine 30 utilizes the layout engine 20 to compute whether the size and shape of a given element variation fits within a region of the layout space which can also depend on the constraints provided by the layout attributes 24. As an example, an element (e.g., an image) might have a width constraint such that it spans two or three columns. However, a three-column width of such element might require a height that exceeds the available space of the complex document, in which case the rules engine ensures that the element would span two columns.

When the layout rules and attributes have been satisfied for a given sequence of element variation, the corresponding layout permutation (e.g., the sequence of element variations) can be stored as part of the valid set of layout permutations. If the layout rules are not satisfied for a given element variation in the sequence, the sequence can be invalidated and the permutation engine 30 can continue to progress recursively through the element variations, such as by adding a variation of another element and employing the layout engine 20 accordingly. If the other variations of the next element do not satisfy the rules 22, the permutation engine 30 can add a next variation of the previous element and employ the layout engine to determine if the layout rules are satisfied. This process can continue recursively progressing until all possible variations of the elements 16 have been processed, thereby resulting in the set of valid layout permutations, which can be stored in the layout data 28 as an ordered sequence of element variations for each respective permutation.

For each layout permutation, the layout permutation engine 30 can also employ a container-specific layout engine at each level of hierarchy of the complex document structure to determine whether a given layout permutation is valid. Additionally, as noted, the permutation engine 30 can determine whether a given layout permutation is valid by ascertaining whether other attributes for a given element are satisfied by the variation of the given permutation. The constraints can be defined, for example, by tags that are stored as attributes with the respective elements, such as can be added by a designer or other source of the content elements. The layout generator 14 can select a given one of the layout permutations, which can be presented to a user via a graphical user interface, such as a browser.

As a further example, the layout generator 14 can rank the set of valid layout permutations, such as according to a layout metric, to ascertain a proper subset of layouts from the set of valid layout permutations that have been determined. The metric can employ criteria established for a given document layout to rank (e.g., order) the set of valid layout permutations to provide the subset of layouts. For instance, the criteria can be to rank the subset of valid layout permutations according to how well the selected set of layout variations fill the page or other regions, such as by computing an amount of white space (e.g., space without content) for each permutation. From the subset of ordered layout permutations, the layout generator can select the top layout. Alternatively, the layout can be selected randomly or pseudorandomly from the subset of valid layout permutations. In a situation where new content has not been added and the layout generator is activated repeatedly for a selected region of the complex document, the layout generator can cycle through the subset of layouts to allow a user to view and compare each of the permutations.

FIG. 3 depicts an example of a hierarchical document structure representation 100 corresponding to a complex document. In one example, the document structure 100 can be implemented as a multi-columnar layout, although other types of layouts can also be utilized. In the example of FIG. 3, the data structure corresponds to a spread, although other types and formats of complex document structures (e.g., a single page or poster) can be generated.

The data structure 100 can be represented as a tree structure having a plurality of container nodes 102, 104, 106 and 108 and a plurality of content nodes 110, 112, 114, 116 and 118. In the example of FIG. 3, the content nodes 110, 112, 114, 116 and 118 are implemented as leaf nodes corresponding to the container nodes 102, 104, 106 and 108. Each of the container nodes 102, 104, 106 and 108 includes a layout 120, 122, 124 and 126. As mentioned above with regard to FIG. 1, each of the layouts can include a rules engine that employs rules and attributes to control the layout of elements that lie in each respective container. In one example, each of the layout engines 120, 122, 124 and 126 can be a columnar layout engine. The hierarchy of nodes in the data structure thus prescribes the influence of each layout engine over the branches and child nodes in the hierarchy. The actual layout of the elements 110 and 112 in the document is determined by the layout engine 122, and the layout of the elements 114 and 108 in the document is determined by the layout engine 124.

In the example structure 100, the root node (“SPREAD”) 102 has two child nodes (“PAGE 1” and “PAGE 2”) 104 and 106. Content nodes (“ELEMENT 1” and “ELEMENT 2”) 110 and 112 are leaf nodes of the container node 104. The container node 106 has as its children content node (“ELEMENT 3”) 114 and container node 108. The container node 108 is itself a container structure (“nested container”) that includes the layout (e.g., comprising a layout engine, rules and attributes) 126 to determine the resulting layout of its child leaf node elements (“ELEMENT 4” and “ELEMENT 5”) that are contained therein. For example, the nested container 108 comprises a nested layout 126, which can be another columnar layout or other type of layout (e.g., BRIC layout).

Each of the content elements 110, 112, 114, 116 and 118 includes associated attributes 132, 134, 136, 138 and 140 (e.g., stored in memory). The attributes 132, 134, 136, 138 and 140 can specify attributes for each of the elements, such as size constraints, position constraints or logical relational constraints for one or more of the content elements. Other element attributes can include component type, component authorship and component revenue or cost. A given complex document can be formed of multiple spreads, which may be the same or different depending on the layout format of each container. The example of FIG. 3 demonstrates but one example of a hierarchical representation for a complex document that can be utilized to generate a columnar layout, as disclosed herein. Various other structures and content can be utilized based on the teachings herein.

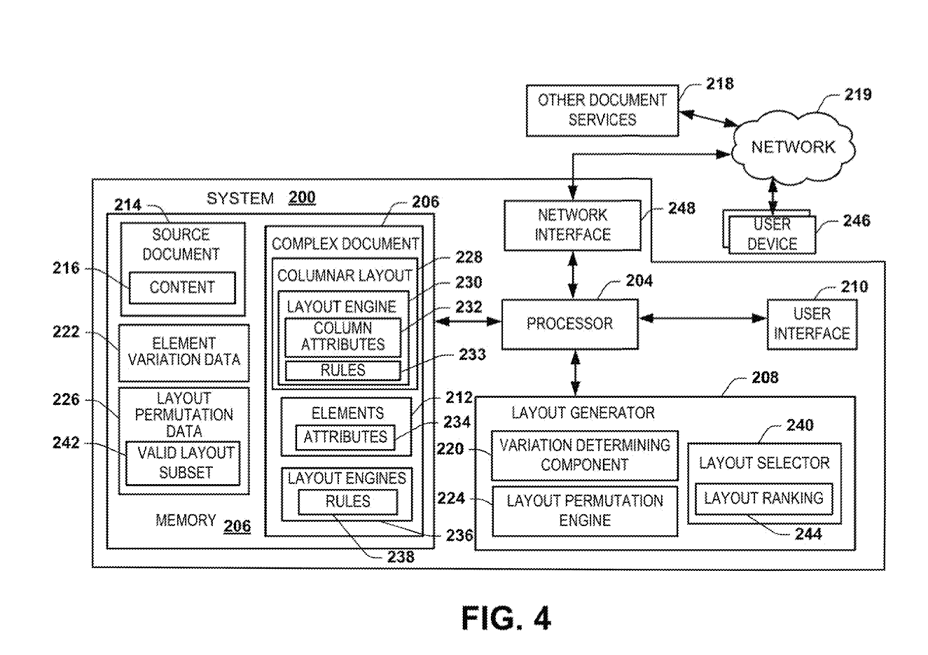

FIG. 4 depicts an example of another system 200 that can be implemented to generate a layout for a complex document 202. While the example system 200 of FIG. 4 demonstrates generating a columnar layout, it will be understood and appreciated that the system 200 can be implemented to generate other types of layouts based on the teachings herein.

The system 200 can include a processor 204 configured to access memory 206 and execute instructions, demonstrated as including a layout generator 208. The layout generator 208 thus can be stored as computer executable instructions in memory 206 that can be accessed by the processor. For instance, the memory 206 can comprise physical memory, such as can reside on the processor 204 (e.g., processor memory), random access memory or other physical storage media (e.g., a CD ROM, DVD, flash memory, hard disk drive, etc.) or a combination of different memory devices that can store the computer readable instructions. The complex document 202 and associated data can also be stored in the memory as computer readable data that can be accessed by the processor 204.

By way of example, the processor 204 can activate the layout generator 208 in response to instructions received via a user interface 210. For instance. a user can employ the user interface 210 to access a source complex document 214 that contains content elements 216, The user can drag selected content 216 from the source document 214 into the target complex document 202, which can activate the layout generator 208. The user interface 210 can also provide instructions to the processor 204 to invoke the layout generator 208, such as in response to a graphical user interface (GUI) button or key being selected. Alternatively or additionally, the layout generator 208 can be invoked by another application, demonstrated as document services 218, which is connected to the system 200 via a network 219, The layout generator 208 can be implemented as part of document services in a cloud computing environment that includes the other document services 218. The user interface 210 can also provide a GUI to select or manipulate content elements 212 in the complex document 202.

The layout generator 208 includes a variation determining component 220 to determine a set of element variations far each of the elements 212 in the complex document 202. A set of element variations for each of the elements 212 in the complex document 202 can be stored in the memory 206 as element variation data 222. The variations of each of the elements 212 can correspond to variations in size and shape of each respective element. The number of variations for each element can be constrained by element attributes 234. The number of variations thus can be the same for each element or different numbers can be determined for different elements. As mentioned above, the variation determining component can determine the element variations recursively for each element, such as progressing through the elements within the hierarchy of the structured content defined by the complex document.

The layout generator 208 can also include a layout permutation engine 224 to provide a set of different layout permutations by arranging the variations of the document elements 212 in a predetermined layout, such as a columnar or other layout. The layout permutation engine can store valid layout permutations in the memory 206 as ordered sequences of element variations corresponding to each permutation, demonstrated as layout permutation data 226.

In the example of FIG. 4, the complex document 202 has a columnar layout 228 that includes a columnar layout engine 230 that defines the column structure for the document according to column attributes 232. Examples of column attributes include a column width attribute, a column height attribute, an inter-column gap attribute and the like. The columnar layout engine 230 computes an arrangement for each of the elements in the layout format 228 based on the column attributes. The columnar layout engine 230 can also employ rules 233 to ensure that the arrangement of each content element variation is valid according to the constraints provided by the rules. For example, the columnar layout engine 230 can employ the rules 233 to ensure that content element within a respective column is not smaller than the width of the column. Other rules can also be provided to ensure a valid arrangement of elements in each permutation of elements for the document 202.

The elements 212 also have attributes 234 that can constrain the size and/or position of a particular element for each permutation of columnar layout. As an example, if a columnar layout has three columns, and a given one of the elements 212 has an attribute 234 requiring a minimum width of two columns, then, in the example three-column layout, the given element would be limited to a width of two columns plus one inter-column gap or three columns plus two inter-column gaps. However, the layout engine can employ rules 233 to ensure that such widths result in a valid layout. For a given width constraint, the columnar layout engine 230 can determine if the height of the given element fits within the available space and whether enforcing such is balanced against the constraint of arranging all the elements of the columnar layout within the available space available. For example, an element such as an image might have a width constraint, such that it spans two or three columns, but a three-column width might require a height that exceeds the available space, in which case the image would span two columns.

In addition to the constraints provided by the columnar layout engine, the layout permutation engine 224 can also employ corresponding layout engines 236 provided at each level of hierarchy of the complex document 202, The layout engines 236 can apply corresponding rules 238 to determine whether a given layout permutation for a set of element variations is valid. This can be done for each variation of each element in a given sequence.

By way of further example, the permutation engine 224 can determine each permutation as a sequence of valid element variations. For instance, a first element variation can be added as the first element in a sequence of elements. As shape variations for other elements become available, the permutation engine 224 can add one shape variation of each element as subsequent elements in the sequence. If a valid sequence contains one variation of every element of a container (including one variation of every nested container), then the sequence constitutes a valid permutation (Le. sequence) of the elements.

Additionally, the permutation engine 224 can be programmed to efficiently evaluate permutations, such as to avoid computing unnecessary permutations in situations where one or more nested layouts exist in the complex document 206. To help ensure that layouts remain tractable for documents comprising nested layouts, the permutation engine can be programmed to provide only one shape variation for each element variation that is considered by the parent container. As an example, consider a columnar container configured with three columns and having within it an image element and a nested columnar container. In this example, the rules of a columnar layout may require that the height options for the image element be determined for each of the width options corresponding to the widths of one, two and three columns plus zero, one and two inter-column gaps respectively. In the case of the nested container, in an example, the permutation engine can be programmed as to consider only one height option for each of the three width options despite the fact that different layouts of the nested container could give rise to multiple different height options for a single width option.

Thus, in this example implementation, the layout engine associated with the nested container chooses one height option for each width such that the chosen height provides the maximum number of different highly ranked layout options for the nested container if it were to be laid out according to width and height option. Alternative choices for the height to be paired with each width option can include, for example, the height that gives the highest layout rank, or the greatest height that gives a valid layout, or the least height that gives a valid layout.

For each element added to a sequence by the permutation engine 224, the shape variation of the element and the accumulated shapes of all previous elements can be used by the layout engines 230 and 236 to determine whether the element invalidates the sequence. For example, a columnar layout might have layout rules that require each element be added starting at the top left corner and progressing across then down the layout region with the top left corner of each added element being placed at the left edge of the topmost available space. Additionally, if a two column wide variation of an element was the first element added at the top left of a three column layout space, according to the layout rules, the next element would be added at the top of the third column. Accordingly, if the third element had a shape variation having a width of more than one column, it could not fit in the required position and hence any permutation beginning with these two element variations may be invalid. Thus, the layout permutation engine 224 can identify and stored invalid sequences and thereby, upon recognizing a repeat of such sequence, it can avoid adding further elements to that particular sequence.

By way of further example, if an added element fits in the next required position (e.g., it is valid), the permutation engine 224 can continue the sequence by adding a variation of another element. If an added element does not fit, then the permutation engine can add an alternative variation of the same element in place of the element variation that failed. It it is added successfully, the permutation engine 224 can add a variation of another element. If it is not added successfully then another variation should be tried and so on. If there are no more variations for a given element, then the permutation engine removes the tailed element from the sequence and the previous element in the sequence should be replaced by an alternative variation thereof. Each time a valid sequence of elements is generated (e.g., having exactly one variation of every element), the sequence can be stored as layout permutation data 226 in the memory 206, corresponding to a valid permutation of the elements.

The permutation engine 224 can continue this process until all permutations have been tried or it may terminate early. For example, the permutation engine 224 might continue only until a sufficient number of valid permutations have been found, or until a certain period of computation has elapsed.

Additionally or alternatively, the permutation engine 224 can be programmed to add candidate elements and to select candidate variations for the sequence according to various strategies. For example, the permutation engine 224 may be programmed to add candidate variations in a random or pseudo-random order, such as to identify a set of widely differing permutations. As another example, the permutation engine 224 may add candidate variations in an order that takes account of the space available at the position defined by the layout rules.

In view of the foregoing, it will be appreciated that the approach described herein can efficiently record valid layouts (e.g., as a sequence of element variations), without explicitly recording the shapes and positions of the individual elements. Additionally, the permutation engine 224 can identify invalid permutations early to drastically reduce the number of candidate layouts. The permutation engine 224 can also achieve efficiencies by pruning element sequences according to layout rules, specific attributes of a layout and the elements it contains can also be used to invalidate a sequence. For example, a particular element might have an attribute that indicates it comes first in the layout sequence or that it is to be positioned centrally within the layout.

Despite the constraints on the number of column widths and corresponding heights, such as described herein, the layout generator 208 can sometimes determine many hundreds, thousands or even millions of valid layout permutations. The layout generator 208 thus can also include a layout selector 240 to select a subset of one or more valid layout permutations. The layout selector 240 can store a valid layout subset 242 in memory 206. The layout selector 240 can determine the valid layout subset 242 as a fixed or variably-sized subset that contains the highest ranked permutations. For example, a variably-sized subset can be defined up to a maximum number that is a function of the number of child elements. Alternatively, the valid subset of permutations can be randomly or pseudo-randomly selected from the superset of permutations determined to be valid.

As a further example, the layout selector 240 can include a layout ranking component that applies a metric to ascertain the valid layout subset 242. The metric can employ criteria established for a given document layout to rank (e.g., order) the set of valid layout permutations to provide the subset of layouts. For instance, the criteria can be to rank the subset of valid layout permutations according to how well the selected set of layout variations fill the page or other regions, such as by computing an amount of white space (e.g., space without content) for each permutation. As one example, the ranking component 244 can be programmed to assign the same relative ranks as a skilled graphic designer.

As a further example, the ranking component 244 can be programmed to rank all valid layout permutations of the columnar layout, which ranking can be used to provide the valid layout subset 242. Alternatively, the ranking component 244 can identify one or more valid layouts without exhaustively comparing all valid layout permutations and/or without necessarily determining that the layout is better or more appropriate than others. This can be efficient when the number of layout permutations is very large. For instance, such an implementation can employ a non-exhaustive search strategy and employ a metric for the absolute layout effectiveness rather than the relative rank.

The resulting columnar layout of the complex document 202 can be displayed in a browser window. For instance, a user device can access the system 200 via the network 246 and individual text, graphic or image elements can be selected by pointing to the elements via the user interface 210. A container can be selected by pointing at a margin drawn around its elements or a gap between its elements or by a region revealed when the pointer is in the neighborhood of the containers elements. Document creation and editing is accomplished by dragging a selected element or a container on to other elements or containers, such as via the user interface 210. Dragging an element on to another element indicates a replace operation, which can activate the layout generator 208 to provide a new columnar layout with the substituted content. Dragging an element on to a container indicates an operation to add the element to the container, which can activate the layout generator 208 to provide a new columnar layout with the additional content.

A user can also employ the user interface 210 or other user input mechanism to implement alternative layouts. For example, a user can cycle through alternative columnar layout permutations (e.g., from the valid layout subset 242) to allow the user to view and compare each of the valid layout permutations. The layout permutations can be cycled through in an order that permits the user to return to the original layout. If a subset of more than one valid layout is determined, that the valid layout subset 242 can be determined to be the best or most appropriate subset of all the alternatives.

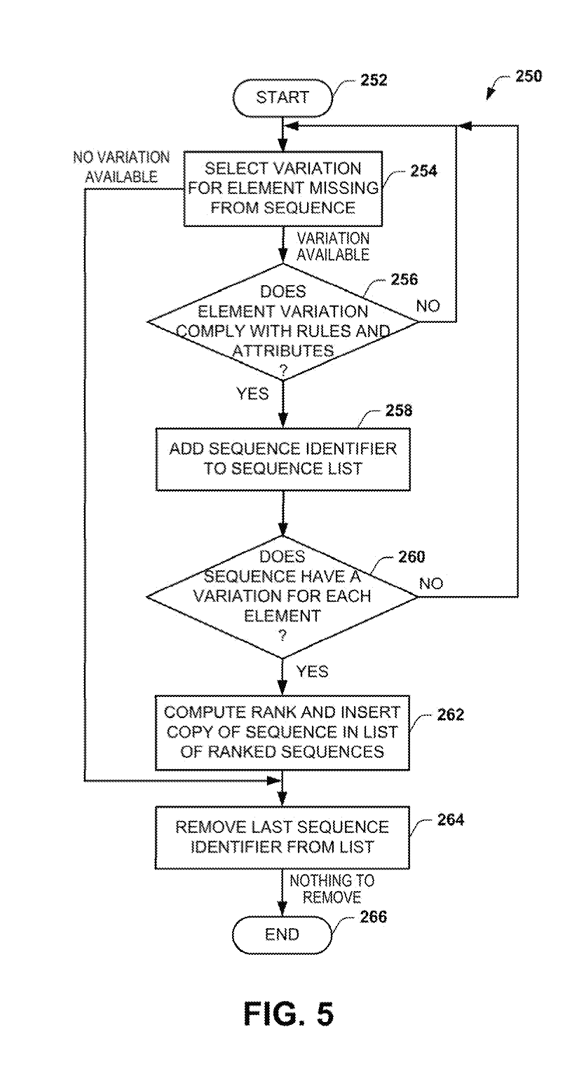

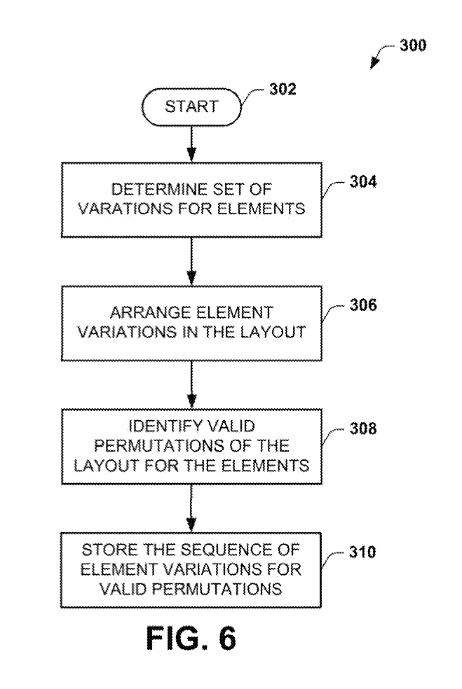

In view of the foregoing structural and functional features described above, an example method will be better appreciated with reference to FIGS. 5 and 6. While, for purposes of simplicity of explanation, the example methods of FIGS. 5 and 6 are shown and described as executing serially, it is to be understood and appreciated that the examples are not limited by the illustrated order, as some actions could in other examples occur in different orders and/or concurrently from that shown and described herein. The methods of FIGS. 5 and 6 can be implemented as computer executable instructions by a processor (e.g., the processor 204 of FIG. 4) or stored in memory (e.g., memory 206 of FIG. 4) as computer readable data.

FIG. 5 depicts an example of a method 250 that can be implemented (e.g., by the layout permutation engine 30 of FIG. 1 or 234 of FIG. 4) to determine sequences of element variations corresponding to valid layout permutations. The method 250 begins at 252, such as in connection with providing a set of sequences, which initially is a null set when the method is invoked.

At 254, an element variation is selected. The selected element variation corresponds to an element that is not already in the current sequence and to a variation of the element that has not previously been selected (e.g., at 258) for addition to the current sequence and to a variation of the element that has not previously been selected at 254 for addition to the current sequence. If a variation is available, the method proceeds to 256 to test the sequence. For example, at 256, a determination is made as to whether the selected element variation can be added to the current sequence without breaking the rules of the layout engine and whether the choice is consistent with the layout attributes and element attributes. If the element can be added without violating the layout rules and is consistent with the layout attributes and element attributes, the method can proceed from 256 to 258. If not, the method returns to 254 to select another variation of the respective element. Alternatively, if no further variations exist a variation of another element can be selected.

At 258, a sequence identifier for the current permutation is added to the end of a sequence list. For example, this may be implemented by adding a number pair (I, J) to a linked list of number pairs that represents the sequence, where I indicates that the I^{th} child element was chosen and that the J^{th} shape variation of that element was chosen. From 258, the method proceeds to 260.

At 260, a determination is made as to whether the sequence has one variation of every element that is a direct child of the layout container. If this determination is positive (YES), the method proceeds to 262. If the determination is negative (e.g., indicating that further element variations exist), the method proceeds to 254. If it is determined at 260 that the sequence has one variation of every element that is a direct child of the layout container, the method proceeds to 262.

At 262, a rank (N) is computed for the sequence and a copy of the entire sequence is inserted in a rank-ordered list (e.g., a linked list) of sequences. Additionally, the copy of a sequence can be removed from the list if its rank position is pushed beyond some threshold number by the addition of a higher ranked sequence. From 262, the method proceeds to 264 to remove the most recently added sequence identifier from the list (e.g., a number pair in a linked list). Additionally, if at 254, it is ascertained that no further variation can be selected (e.g., all variations of all elements not in the current sequence have previously been selected at 254 for addition to the end of the current sequence), the method can also proceed from 254 to 264. From 264, the method returns to 254. Alternatively, if it is determined that the linked list of sequence identifiers is already empty, there are no more valid layouts and the method can proceed from 264 and end at 266.

Other recursive or r on-recursive implementations are possible, and many optimizations are possible. For example, the method can terminate the search for valid sequences early without considering all permutations of elements and variations.

FIG. 6 depicts an example of a method 366 for generation of a layout for a complex document. In an example, the method is an automated method. The method begins at 302 in which a layout generator is invoked for columnar layout of a complex document, such as in response to a user input or a call from an associated application. At 304, a set of variations is determined (e.g., by a variation determining component 220 of FIG. 4) for each element of a plurality of document elements_{:} the document elements corresponding to hierarchical structured content. At 306, each of the variations of the document elements is recursively arranged (e.g., by the layout permutation engine 224) in the columnar layout to provide a set of different layout permutations. At 308, a subset of layout permutations is selected (e.g., by layout selector 240 of FIG. 4) based on the set of different layout permutations. At 310, the subset of layout permutations can be stored in storing the subset of the layout permutations in memory (e.g., memory 206 of FIG. 4).

What have been described above are examples. It is, of course, not possible to describe every conceivable example of the invention, but one of ordinary skill in the art will recognize that other example embodiments are possible. Accordingly, this disclosure is intended to embrace all embodiments, such as including alterations, modifications, and variations that fall within the scope of the appended claims. Additionally, where the disclosure or claims recite “a first,” or “another” element, or the equivalent thereof, it should be interpreted to include one or more than one such element, neither requiring nor excluding two or more such elements.

What is claimed is:

1. A system (10, 200) to arrange content in a layout, comprising:
memory (206) to store computer executable instructions; and
a processor (204) to access the memory and execute the computer executable instructions, the computer executable instructions comprising:
a layout generator (14, 208) to determine element variations for each of a plurality of document elements (16, 212) of a layout of hierarchically structured content (18, 228) and to arrange each of the element variations in the layout to determine plural different permutations for the layout based on layout rules at each level of hierarchy of the layout.

2. The system of claim 1, wherein the layout generator (14, 208) further comprises a variation determining component (26, 220) to recursively determine size and shape variations for each of the document elements (16, 212), corresponding to the hierarchically structured content for a complex document, the element variations being stored in the memory as element variation data (28, 222).

3. The system of claim 2, wherein the layout generator (14, 208) stores in the memory a sequence of the element variations identifying each set of element variations for a valid set of the permutations of the document elements according to the layout rules (22, 238, 233) and attributes (24. 232, 234) of a layout engine associated with the layout.

4. The system of claim 4, wherein each of the document elements comprises attributes (234) to constrain its number of element variations that are available for determining the plural different layout permutations.

5. The system of claim 2, wherein the layout generator (14, 208) further comprises a layout permutation engine (30, 224) to recursively arrange each of the document elements, corresponding to a selected one of element variations, in the layout to provide plural different layout permutations for the elements in the layout, the plural different layout permutations being stored in the memory as layout permutation data.

6. The system of claim 4,
wherein the layout (18, 228) is a columnar layout (228), wherein the layout permutation engine (30, 224) employs a columnar layout engine (230) to determine a set of valid layout permutations, the layout rules associated with the hierarchically structured content constrain the set of valid layout permutations such that the arrangement of elements of the layout span at least one whole column of the columnar layout.

7. The system of claim 6, wherein the layout permutation engine (30, 224) is further programmed to layout each of the document elements in the columnar layout by recursively progressing to layout permutations at lower levels of hierarchy in the hierarchically structured content.

8. The system of claim 1, wherein the layout generator (14, 208) further comprises a layout selector (240) comprising a ranking component (244) to employ a metric to rank a subset of the layout permutations, the layout selector selecting the display layout from the ranked subset of layout permutations.

9. The system of claim 2, wherein the layout (18, 228) comprises a columnar layout comprising columnar attributes to define a structure of the columnar layout, the layout generator further comprising a layout permutation engine to arrange each of the element variations in the columnar layout, the layout permutation engine employing a columnar layout engine to align each of the document element variations in each of the different layout permutations of the columnar layout and to determine a set of valid layout permutations according to columnar layout rules and the columnar attributes.

10. The system of claim 1, wherein one of the document elements (16, 212) in the hierarchical structured content, corresponding to a complex document (12, 100, 206) comprises a nested layout (108) that is arranged within the layout by a layout engine according to the layout rules, the nested layout comprising another layout engine (126) to arrange document elements (116. 118) of the nested layout.

11. A computer readable medium having computer executable instructions comprising:
a variation determining component (26. 220) to determine a set of element variations for each element of a plurality of document elements (16, 212), the document elements (16, 212) corresponding to hierarchically structured content of a complex document (12, 206) having a predetermined layout (18. 228);
a layout permutation engine (30, 224) to recursively arrange each of the document elements, corresponding to a selected one of the element variations populated in the complex document in a sequence of element variations, in the predetermined layout, the layout permutation engine employing a layout engine (20, 230) of the predetermined layout to determine a plurality of valid layout permutations for the predetermined layout based on layout rules applied for each of the element variations in the sequence of element variations; and
a layout selector (240) to select a layout for the set of document elements based on the plurality of valid layout permutations.

12. The computer readable medium of claim 11, wherein the complex document (12, 206) comprises a layout engine (20, 236) at each level of hierarchy in the complex document, the layout permutation engine employing a respective layout engine at each level of hierarchy, recursively progressing to lower levels of the hierarchy, to determine if an arrangement of the element variations in the sequence of element variations for a given layout permutation is valid based on rules associated with the respective layout engine, the layout selector (240) selecting a layout permutation for display from a set of valid sequences of element variations stored in memory.

13. The computer readable medium of claim 12, wherein a given one of the document elements (16, 212) of the complex document (12, 100, 206) comprises a nested layout (108) that arranged in the as a document element at a corresponding level of hierarchy in the predetermined layout based on a layout engine of a document container in which the nested layout resides, the nested layout comprising another layout engine (126) to arrange document elements (116, 118) of the nested layout

14. The computer readable medium of claim 12, wherein the layout selector (240) further comprises a ranking component (244) to rank each of the valid permutations according to a metric to provide a ranked set of the valid layout permutations, the layout selector selecting a given permutation from the ranked set of valid layout permutations.

15. A method (300) comprising:
determining element variations for each document element of a plurality of document elements of a complex document, the document elements corresponding to hierarchically structured content corresponding to a defined layout, the element variations for each document being stored in memory as element variation data (302);
arranging each of the element variations in the defined layout according to a sequence of element variations (304);
identifying each sequence of element variations corresponding to a valid permutation of the defined layout for the plurality of document elements based on layout rules and attributes of the defined layout (306); and
storing the sequence of element variations for a set of the valid permutations in memory as layout permutation data (308).
